(19) United States
(12) Patent Application Publication
(10) Pub. No.: US 2026/0324599 A1
(43) Pub. Date: Oct. 22, 2026

(54) DEVICE FOR LEADING AN ANIMAL AND A LEASH FOR LEADING AN ANIMAL

(71) Applicant: Christoph GRAF, Heidelberg (DE)

(72) Inventor: Christoph GRAF, Heidelberg (DE)

(21) Appl. No.: 19/109,889

(22) PCT Filed: Aug. 21, 2023
(86) PCT No.: PCT/DE2023/200172

§ 371 Date: Mar. 7, 2025

(30) Foreign Application Priority Data
Sep. 7, 2022 (DE) 10 2022 209 323.2

(51) Int. Cl. A01K 27/00

(52) U.S. Cl. CPC A01K 27/005; A01K 27/003

(57) ABSTRACT

A device for leading an animal, in particular a dog or a horse, by two people. The device includes a first leash. A first free end of the first leash can be connected to a collar or a harness or a halter. A second free end of the first leash has a gripping region for a first person. A second leash is connected to the first leash in such a manner that, if a defined pulling force is exceeded, the connection between the first leash and second leash is released.

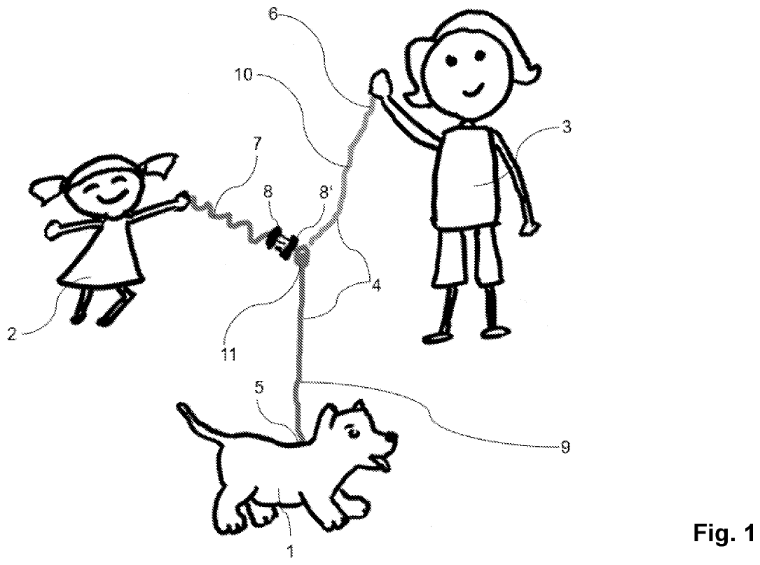

### CROSS REFERENCE TO RELATED APPLICATIONS

This application is a 35 U.S.C. § 371 National Stage of International Patent Application No. PCT/DE2023/200172, filed Aug. 21, 2023, designating the United States, which claims priority to and the benefits of German Patent Application No. 102022209323.2, filed Sep. 7, 2022, the disclosures of which are incorporated herein in their entirety by reference, and priority is claimed to each of the foregoing.

### FIELD OF THE INVENTION

The invention relates to a device for leading an animal, in particular a dog or a horse.

The device further relates to a leash for leading an animal, in particular a dog or a horse.

It is known from practice to lead animals on a leash. Very different devices are already known depending on the animal and situation, for example retractable leashes, trailing leashes, lunging lines, etc. In principle, it is assumed that the animal to be lead is lead by a single person and the respective leash does not become released even under tension.

If a child grows up in a household with a dog or otherwise is likely to have significant contact with dogs, parents are confronted at some point with the question of how the child and dog can become acquainted with one another safely when going for a walk. Low body weight, too little strength and lack of experience make it impossible to give a child sole responsibility. If the dog suddenly runs off onto a road, this can result in injuries not only for the dog but also for the child. Insurance is essential.

By clipping two leashes, which are independent of one another, to the collar or the harness, the adult person can keep the dog under control by means of the first leash and at the same time provide the child with the sensation of leading the dog by handing over the second leash. If the dog moves away to the side from the side opposing the child, however, the leash of the child reaches its full tension first, while the leash of the adult person still hangs loosely. This can lead to injuries, for example by the sudden pulling on the arm of the child and/or by the child falling over as a result thereof.

### SUMMARY OF THE INVENTION

The object of the present invention, therefore, is to design and develop a device for leading an animal in such a manner that the animal can be safely lead by a physical and/or mentally impaired person using structurally simple means. A leash for leading an animal is also intended to be specified.

According to the invention, the above object is achieved by the features of claim 1. Thus a device for leading an animal, in particular a dog or a horse, by two people is claimed, comprising a first leash, wherein a first free end of the leash can be connected to a collar, harness or a halter, wherein a second free end has a gripping region for a first person, wherein a second leash is connected to the first leash in such a manner that, if a defined pulling force is exceeded, the connection between the first leash and second leash is released.

According to the invention, it has firstly been recognized that the underlying object can be achieved in a surprisingly simple manner by the second leash, which is held by the “impaired person”, for example the child, being released from the first leash with which the animal is lead, if a defined pulling force is exceeded. Since the pulling force is adjusted to a correspondingly low level, for example, even very young children can “lead” the animal, wherein it is ensured that, if the animal runs off or pulls, the connection between the child and animal is released. However, it is ensured that the “actual leader” of the animal, in particular an adult, can always hold the animal since the first leash, which is held by the adult, is configured in the manner of a conventional leash and thus also withstands the animal suddenly pulling or running away. The first free end of the leash can be connected to a collar, a harness, a halter or any other element of the animal, for example via a snap hook or the like, so that a connection to the animal is created.

By means of the device according to the invention, an “impaired person” can thus lead an animal safely without there being a risk to this person, the animal or a third party, and namely the animal is held safely by the “actual leader”. It is essential to the device according to the invention that the connection between the second leash and the first leash is released if a defined pulling force is exceeded, wherein this pulling force should be defined to be sufficiently low that people with an impaired physical and/or mental capacity are protected from injuries. The term “child” is used hereinafter for simpler discussion of the invention, wherein this is to be understood to mean a person of any age who is not capable of leading an animal for physical and/or mental reasons.

The term “leash” is to be understood in the broadest sense within the scope of this disclosure, namely it can be a dog leash, a lead rope, etc.

Advantageously, the first leash and the second leash can have connecting elements which are complementary and/or correspond to one another in order to implement the connection between the first leash and second leash. Thus a connection can be implemented in a simple manner. Alternatively, it is conceivable that the entire device is configured in one piece, wherein the second leash has a material weakening or the like, so that the second leash breaks if the defined pulling force is exceeded.

In a further advantageous manner, the connecting elements can have a magnetic and/or a magnetizable material. Thus it is possible to implement a magnetic connection which is simple in terms of construction and handling. A further advantage is that the strength of the magnetic connection can be accurately adjusted. Specifically both connecting elements could be implemented in each case by at least one permanent magnet, for example a ferromagnet or a magnet containing neodymium-iron-boron.

Alternatively or additionally, it is conceivable that the first connecting element and the second connecting element can be connected to one another non-positively and/or positively. This could be a plug connection or clamped connection or the like. It is essential that the construction ensures that the connection is reliably released if a defined pulling force is exceeded, but otherwise a fixed connection is provided.

According to an advantageous embodiment, the defined pulling force is in a range from 10 N to 90 N, in particular from 15 N to 60 N, preferably from 25 N to 35 N. Provided the pulling force is in this range, on the one hand it is possible for the child to lead the animal, wherein on the other hand a danger is eliminated.

Advantageously, the defined pulling force can be adjusted. Thus the pulling force can be correspondingly adjusted to the strength or the age of the child and the animal to be lead. This could be carried out, for example, by varying the number and/or the strength of the permanent magnets used.

Moreover, it is advantageous if the second leash comprises an elastic material or is configured to be elastic, at least in some regions. As a result, a pulling of the animal on the leash can be “cushioned”.

In a further advantageous manner, the first leash can be configured in two parts, wherein a first part, which can be connected to the collar or the halter, and a second part, having the gripping region, are preferably releasably connected to one another. For example, the first part and the second part could be connected to one another via a snap hook hook or the like. Alternatively, it is conceivable that the first part and the second part are unreleasably connected to one another via an eyelet or the like. Irrespective of the actual connection implemented, it is also conceivable that the second leash is connected to the first leash in the region of the connection of the first and second part.

In a particularly advantageous manner, the second leash could be connected, preferably releasably, to the first part of the first leash which can be connected to the collar or the halter. If in the first leash the second part is releasable from the first part, in particular via a snap hook or a similar construction, there is the possibility of removing the second part of the first leash from the device, for example in a safe environment, in particular an enclosed garden, so that the child can actually lead the animal alone via the second leash which is connected to the first part. There is still the guarantee that the second leash is released from the first part of the first leash if the defined pulling force is exceeded. In a further advantageous manner, the complementary, in particular magnetic and/or magnetizable, connecting elements could be arranged on the first part of the first leash and on the second leash, so that the second leash is connected to the first part via these connecting elements. The first part could have the connecting element on the same fastening element to which the second part is also able to be secured, for example an eyelet or a loop. Alternatively, a separate fastening element could be provided for the connecting element on the first part, for example a loop or an eyelet.

According to an advantageous embodiment, the first part and the second part could have a different color. Alternatively or additionally, the first part of the first leash and the second leash could have an identical color. Specifically, the first part of the first leash and the second leash could be kept in a bright or conspicuous color, but the second part could be configured in a color which is as inconspicuous as possible or preferably transparent. As a result, the child has the sensation of actually leading the animal alone.

Relative to the leash, the underlying object is achieved by the features of the independent claim 13. Thus a leash for leading an animal, in particular a dog or a horse, is claimed, preferably for use in a device as claimed in one of claims 1 to 12, having a connecting means for producing a connection to a further leash or a collar or a halter, wherein the connection to the further leash is released if a defined pulling force is exceeded.

By means of the leash according to the invention, it is possible to provide, by the connection to a conventional leash, a device which enables a child to lead a dog safely. The leash according to the invention could have a connecting means, for example two connecting means of complementary design which can be attached to a conventional leash, for example can be clipped to a ring. It is also conceivable to fasten the leash according to the invention directly to the collar or the halter of the animal. If a defined pulling force is exceeded, the connection opens so that the child is protected from injuries but the animal is held by the adult using the conventional leash.

It should be mentioned that the leash according to claim 13 can have the features and advantages of the second leash described by the claims 1 to 12.

As a whole, the leash according to the invention has the following advantages: 1) A second, experienced person who is physically larger than the dog always has the option of keeping the dog under control. 2) The child has at the same time the impression of leading the dog themselves. 3) In situations in which both the child and the adult person hold such a leash, the dog can move in all directions without this being able to cause the child to fall over. 4) In situations in which only the child holds this leash, if the dog runs off this does not cause the child to fall over.

### BRIEF DESCRIPTION OF THE FIGURES

There are various possibilities, therefore, for designing and developing the teaching of the present invention in an advantageous manner. To this end, on the one hand, reference can be made to the claims subordinate to claim 1 and, on the other hand, to the following explanation of preferred exemplary embodiments of the invention by way of the drawing. In combination with the explanation of the preferred exemplary embodiments of the invention, generally preferred designs and developments of the teaching are also explained by way of the drawing. In the drawing: the only figure shows in a schematic view an exemplary embodiment of a device according to the invention.

### DETAILED DESCRIPTION OF THE INVENTION

The drawing shows in a schematic view an exemplary embodiment of a device according to the invention for leading an animal 1, in this case a dog by two people, namely a child 2 and an adult person 3. The device comprises a first leash 4, wherein a first free end 5 of the first leash 4 can be connected to a collar or a halter, not shown.

A second free end 6 of the first leash 4 has a gripping region for a first person 3. Moreover, a second leash 7 is arranged for the child 2. The second leash 7 is connected to the first leash 4 in such a manner that, if a defined pulling force is exceeded, the connection between the first leash 4 and the second leash 7 is released.

In the exemplary embodiment shown here, the first leash 4 and the second leash 7 have connecting elements 8, 8′ which are configured in a complementary manner and which are implemented as permanent magnets.

Moreover it can be identified that the second leash 7 is configured to be elastic, at least in some regions. If the animal 1 moves away to the side, the elasticity of the second leash 7 provided for the child 2 ensures that the child 2 is not pulled along. If the elasticity reaches its limit, for example because the second end 6 of the first leash 4 is not held at this moment, the magnetic connection is released and the child 2 avoids falling over.

In this exemplary embodiment, the first leash 4 is configured in two parts and has a first part 9 which is connected to the collar and a second part 10 having the gripping region. The first part 9 and the second part 10 can be releasably connected to one another, for example via an eyelet 11 and a snap hook, not shown, or the like. The connecting element 8′ of the first leash 4 is arranged on the eyelet 11, wherein the connecting element 8′ can also be arranged on a separate region of the first leash 4, for example on a further eyelet or on a loop. Thus the child 2 can lead the animal 1 in a safe area without an adult person 3, and the second part 10 can be removed from the first part 9. In order to convey the sensation to the child 2 of leading the animal 1 independently or alone, the first part 9 and the second part 7 can be kept in the same, possibly bright, collar, whereas the second part 10 has another, possibly inconspicuous, color or is kept transparent. It is also conceivable that the connection between the first leash 4 and the second leash 7 is kept in the same color as the second leash 7 and the first part 9.

Regarding further advantageous embodiments of the device according to the invention, reference is made to the general part of the description and to the accompanying claims in order to avoid repetition.

Finally, it should be expressly mentioned that the above-described exemplary embodiments of the device according to the invention serve only for explaining the claimed teaching but do not limit it to the exemplary embodiments.
1 Animal
2 Child
3 Adult
4 First leash
5 First free end
6 Second free end
7 Second leash
8, 8′ Connecting elements
9 First part
10 Second part
11 Eyelet

1. A device for leading an animal, in particular a dog or a horse, by two people, comprising a first leash, wherein a first free of the first leash can be connected to a collar or a harness or a halter, wherein a second free end of the first leash has a gripping region for a first person, wherein a second leash is connected to the first leash in such a manner that, if a defined pulling force is exceeded, the connection between the first leash and second leash is released.

2. The device as claimed in claim 1, wherein the first leash and the second leash have connecting elements which are complementary to one another in order to implement the connection between the first leash and second leash.

3. The device as claimed in claim 2, wherein the connecting elements have a magnetic and/or a magnetizable material.

4. The device as claimed in claim 2, wherein the first connecting element and the second connecting element can be connected to one another non-positively and/or positively.

5. The device as claimed in claim 1, wherein the defined pulling force is in a range from 10 N to 90 N, in particular from 15 N to 60 N, preferably from 25 N to 35 N.

6. The device as claimed in claim 1, wherein the defined pulling force can be adjusted.

7. The device as claimed in claim 1, wherein the second leash comprises an elastic material, at least in some regions.

8. The device as claimed in claim 1, wherein the first leash is configured in two parts, wherein a first part, which can be connected to the collar or the halter, and a second part, having the gripping region, are preferably releasably connected to one another.

9. The device as claimed in claim 8, wherein the second leash is connected to the first part of the first leash.

10. The device as claimed in claim 2, wherein complementary connecting elements are arranged on the first part of the first leash and on the second leash.

11. The device as claimed in claim 8, wherein the first part and the second part have a different color.

12. The device as claimed in claim 8, wherein the first part of the first leash and the second leash have an identical color.

13. A leash for leading an animal, in particular a dog or a horse, preferably for use in a device as claimed in one of claim 1, having a connecting means for producing a connection to a further leash, a collar, a harness or a halter, wherein the connection to the further leash, the collar, the harness or the halter is released if a defined pulling force is exceeded.
